(19) United States
(12) Patent Application Publication
(10) Pub. No.: US 2020/0247055 A1
(43) Pub. Date: Aug. 6, 2020

(54) THREE-DIMENSIONAL (3D) PRINTING TO FILL A PRE-MADE PART

(71) Applicants: Baosheng ZHANG, Houston, TX (US); Hui Leng LIM, Houston, TX (US); Jose Ticy LO, Houston, TX (US); HEWLETT-PACKARD DEVELOPMENT COMPANY, L.P., SPRING, TX (US)

(72) Inventors: BOASHENG ZHANG, SPRING, TX (US); HUI LENG LIM, SPRING, TX (US); JO TICY LO, SPRING, TX (US)

(21) Appl. No.: 16/635,044

(22) PCT Filed: Sep. 29, 2017
(86) PCT No.: PCT/US2017/054503

§ 371 Date: Jan. 29, 2020

(51) Int. Cl. B29C 64/336; B29C 64/165; B33Y 10/00

(52) U.S. Cl. CPC B29C 64/336; B33Y 10/00; B29C 64/165

(57) ABSTRACT

In an example of a three-dimensional (3D) printing method, a pre-made part is positioned. Successive layers of material are applied to fill the pre-made part. A composition of the material is dynamically varied such that a mechanical performance of the material changes from a first portion of the filled pre-made part to a second portion of the filled pre-made part.

### BACKGROUND

In three-dimensional (3D) printing, 3D solid parts may be produced from a digital model using an additive printing process. 3D printing may be used in rapid prototyping, mold generation, mold master generation, and short-run manufacturing. Some 3D-printing techniques are considered additive processes because they involve the application of successive layers of build material. This is unlike traditional machining processes that often remove material to create the final part. In some 3D-printing techniques, the build material may be cured or fused. For some materials, this may be performed using heat-assisted extrusion, melting, or sintering. For other materials, this may be performed using digital light projection technology. Other 3D-printing processes utilize different mechanisms to create 3D shapes, such as printing a binder glue.

### BRIEF DESCRIPTION OF THE DRAWINGS

FIG. 1 is a simplified isometric view of an example of a 3D-printing system that may be used in an example of a 3D-printing method;

FIG. 2 is a flow diagram illustrating an example of a 3D-printing method;

FIG. 3A is a perspective view of an example of a computing device;

FIG. 3B is a bottom view of an example of a computing device;

FIG. 3C is a cross-sectional view of an example of a foot connected to a bottom surface of a computing device of FIG. 3A;

FIG. 4A is a perspective view of an example of a mold;

FIG. 4B is a cross-sectional view of an example of a mold of FIG. 4A;

FIG. 4C is a cross-sectional view of an example of a mold of FIG. 4A that has been filled with a build material;

FIG. 5A is a perspective view of another example of a mold;

FIG. 5B is a cross-sectional view of an example of a mold of FIG. 5A;

FIG. 5C is a cross-sectional view of an example of a mold of FIG. 5A that has been filled with a build material;

FIG. 6A is a perspective view of another example of a mold;

FIG. 6B is a perspective view of an example of a mold of FIG. 6A that has been filled with a build material;

FIG. 6C is a cross-sectional view of an example of a mold of FIG. 6A that has been filled with a build material;

FIG. 7A is a perspective view of another example of a mold;

FIG. 7B is a perspective view of an example of a mold of FIG. 7A that has been filled with a build material; and

FIG. 7C is a cross-sectional view of an example of a mold of FIG. 7A that has been filled with a build material.

### DETAILED DESCRIPTION

Computing devices—such as laptops, notebooks, desktops, tablets, mobile devices, etc.—may be damaged by excessive vibration or by impact with hard surfaces or objects. For example, components such as hard drives may be damaged if a computing device is dropped. In another example, excessive vibration may weaken solder joins on circuit boards or loosen cables or connectors within a computing device.

Computing devices may have external components designed to protect against vibrations and impact. For instance, a laptop or notebook computer may have feet attached to a bottom surface. The material used for the feet may reflect engineering tradeoffs. For example, a hard material may be used to produce a foot that may be durable and wear resistant. A hard material may also result in a foot that has poor energy, vibration, and impact absorption. In another example, a soft material may be used to produce a foot with better isolation and that is energy, shock, vibration, and impact absorbent. A soft material may also result in a foot that is less durable, less wear resistant, and more prone to abrasion.

3D printing is an additive manufacturing process that may be used to manufacture components or parts. In one example, 3D printing may be used to manufacture components for computing devices. This disclosure describes some examples of 3D-printing methods using varied compositions of build materials to manufacture parts that have hard exteriors and soft interiors. These parts may be coupled to devices such that the exterior portion of the part may provide durability and wear-resistance, and the interior portion of the part may provide protection against vibration and impact.

The disclosure further describes the use of pre-made parts to enhance 3D-printed parts. Pre-made parts may be manufactured from build materials that may not be suitable or available for 3D printing. These build materials may exhibit properties, such as strength, hardness, durability, and wear-resistance. In some instances, pre-made parts may exhibit these properties in degrees unavailable from parts manufactured by 3D printing. In addition, pre-made parts may accelerate the 3D-printing process because a portion of the finished part may not need to be 3D printed. Pre-made parts may also decrease the overall cost of the finished part where the pre-made part may be produced at a cost less than that of 3D printing the entire finished part. Pre-made parts may also enable forms or geometries for 3D-printed parts that would be difficult to achieve without the pre-made part.

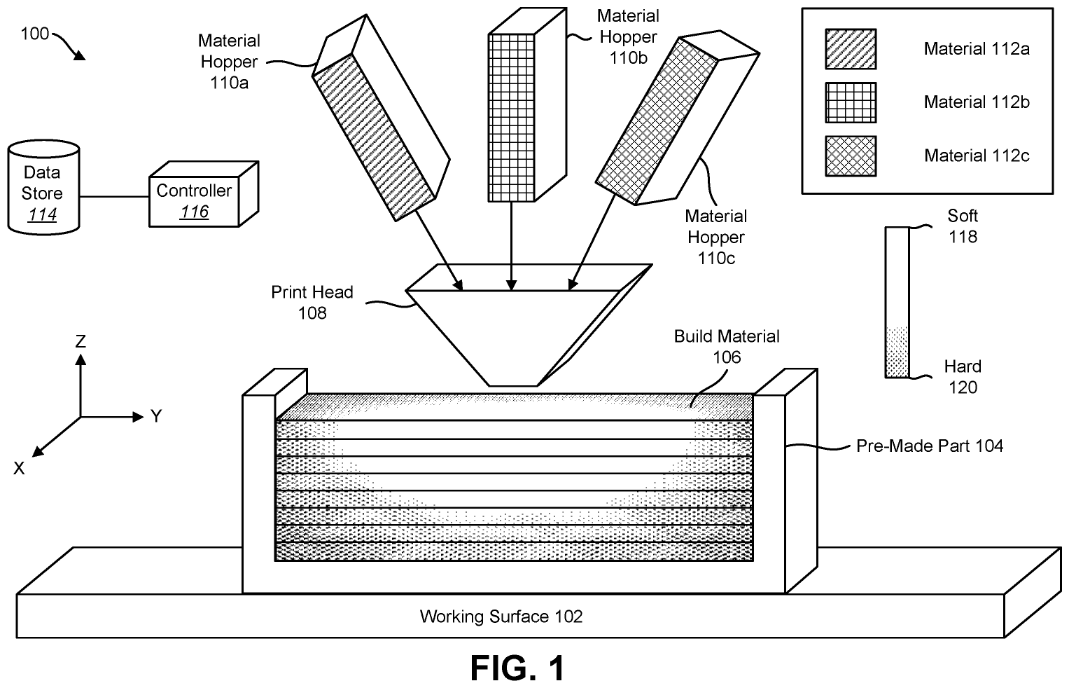

FIG. 1 is a simplified isometric view of an example of a 3D-printing system 100 that may be used in an example of a 3D-printing method. The 3D-printing system 100 may include a controller 116, a data store 114, a working surface 102, a printhead 108, and material hoppers 110a-c. The example of a 3D-printing system 100 in FIG. 1 may include additional components that are not shown, and some of the components described may be removed and/or modified without departing from the scope of the 3D-printing system 100 in this disclosure. The components of the 3D-printing system 100 may not be drawn to scale, and thus, may have a size and/or configuration different than what is shown.

In the example of FIG. 1, the 3D-printing system 100 includes material hoppers 110a-c and materials 112a-c. In other examples, the 3D-printing system 100 may include more or fewer material hoppers 110 and/or materials 112. The material hoppers 110a-c may store materials 112a-c that may be combined to produce the build material 106 that may be used for 3D printing. The material hoppers 110a-c may each store a different material 112a, 112b, 112c and/or different concentrations of the same material. In one example, the material hoppers 110a-c may store dissimilar materials such as powders and/or liquids. In the example of FIG. 1, material hoppers 110a-c are shown with each material hopper 110a, 110b, and 110c storing a different material 112a, 112b, and 112c, respectively.

The materials may have different properties. For example, the materials may have different hardnesses and/or strengths. Some examples of materials that may be used include thermoplastic polyurethanes (TPU), which may have many properties, including adjustable hardness and strength with very high abrasion wear, resistance to oil, heat isolation, and excellent low-temperature and impact performance.

The printhead 108 may successively apply and/or deliver build material 106 to fill or grow a 3D part. The printhead 108 may vary the composition of the build material 106 by mixing different proportions of materials 112a-c received from material hoppers 110a-c. In some examples, the printhead 108 may include functionality to mix materials 112a-c to produce the build material 106 for application. In other examples, a separate feeding material system may mix materials 112a-c received from material hoppers 110a-c and provide the build material 106 to the printhead 108.

The printhead 108 may be, for instance, a thermal inkjet printhead, a piezoelectric printhead, etc. In some examples, the printhead 108 may span a width of the working surface 102. Although a single printhead 108 is depicted, multiple printheads 108 may be used that span the width of the working area. Additionally, printheads 108 may be positioned in multiple printbars. The printhead 108 may also be scanned along the x-axis, for instance, in configurations in which the printhead 108 does not span the width of the working surface 102 to enable the printhead 108 to deposit build material 106 over a large area. The printhead 108 may thus be attached to a moving XY stage or a translational carriage (neither of which is shown) that moves the printhead 108 adjacent to the working surface 102 to deposit build material 106 in predetermined areas of a layer and using gradual hardness within the layers. The printhead 108 may include a plurality of nozzles (not shown) through which the build material 106 is extruded.

The controller 116 may be a computing device, a semiconductor-based microprocessor a central processing unit (CPU), an application-specific integrated circuit (ASIC), and/or other hardware device. The controller 116 may be connected to other components of the 3D-printing system 100 via communication lines (not shown).

The controller 116 may control actuators (not shown) to control operations of the components of the 3D-printing system 100. For example, the controller 116 may control actuators that control movement of the printhead 108 along the x-, y-, and/or z-axes. The controller 116 may also control actuators that control the proportions of material 112a-c that are fed into the printhead 108 from each of material hoppers 110a-c. The controller 116 may further control actuators that raise and lower working surface 102 along the z-axis.

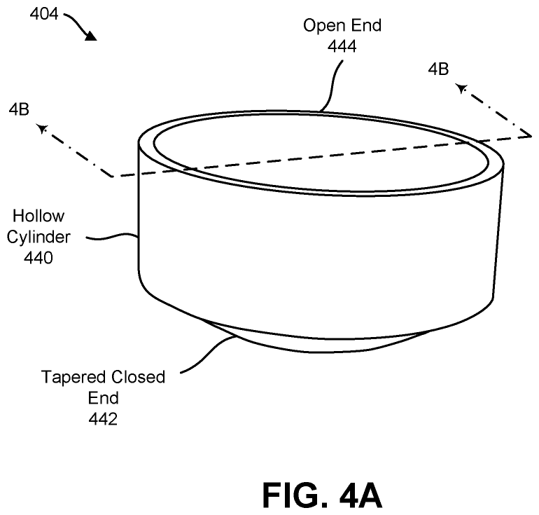

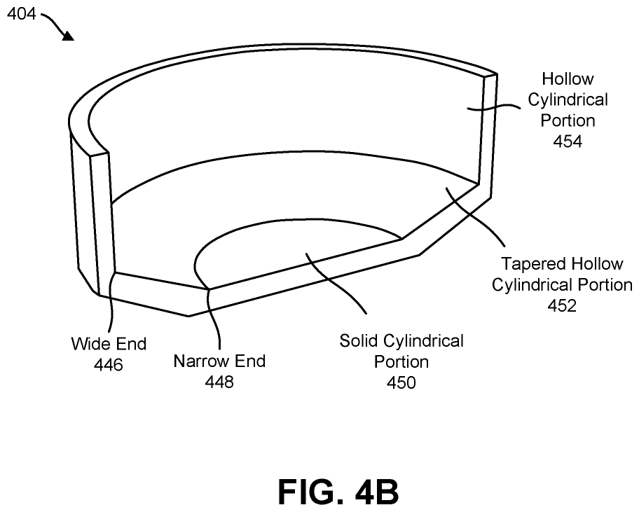

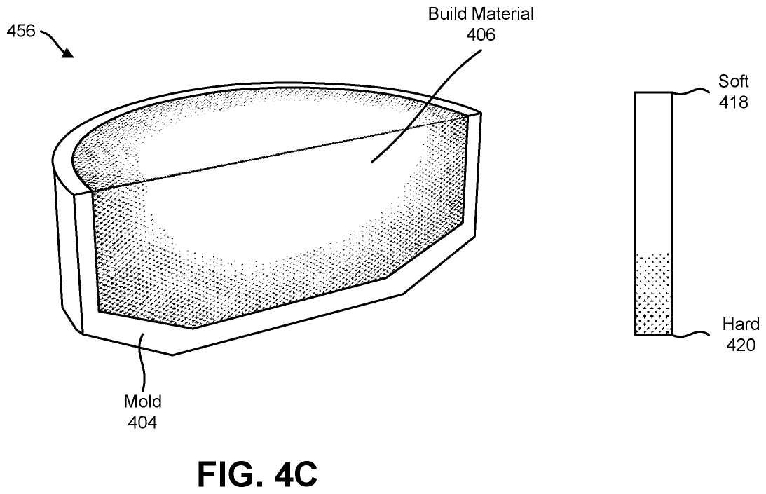

The controller 116 may further control actuators to position a pre-made part or mold 104 on working surface 102. The pre-made part 104 may be positioned so that build material 106 may be successively applied to the pre-made part 104. For example, the pre-made part 104 may be positioned such that 3D printing may be performed on the pre-made part 104 to fill or grow the pre-made part 104 through the successive application of build material 106. The pre-made part 104 may form part of the finished 3D part. The pre-made part 104 may be designed with geometry that is consistent with and/or enhances the finished 3D part. Some examples of pre-made parts or molds 104 are shown in FIGS. 4A-7C and are discussed in more detail below.

The pre-made part 104 may comprise a single material 112 or a plurality of different materials 112. In one example, the pre-made part or mold 104 may be made of a single material 112. The single material 112 may be a wear-resistant material, such as a thermoplastic polyurethane (TPU). One example of a commercially available TPU material may be COIM LARIPUR® LPR8020 Standard Adipate Ester Polyurethane.

The controller 116 may communicate with a data store 114. The data store 114 may include machine-readable instructions that cause the controller 116 to control the supply of material 112a-c by the material hoppers 110a-c to the printhead 108, control movement of the printhead 108, and control the placement of the pre-made part 104 on the working surface 102.

The data store 114 may be machine-readable storage medium. Machine-readable storage may be any electronic, magnetic, optical, or other physical storage device that stores executable instructions. Thus, machine-readable storage medium may be, for example, Random Access Memory (RAM), an Electrically Erasable Programmable Read-Only Memory (EEPROM), a storage drive, an optical disc, and the like. As described in detail below, machine-readable storage medium may be encoded with executable instructions for controlling 3D-printing system 100.

The data store 114 may include data pertaining to a 3D part to be 3D printed by the 3D-printing system 100. For example, the data store 114 may store data pertaining to the geometry of the 3D part. The date store 114 may further store data pertaining to the proportions of materials 112a-c from each of material hoppers 110a-c to be used to produce the build material 106 for each layer and/or each voxel of the 3D part.

In one example, the controller 116 may communicate with a data store 114 to control actuators that control the components of the 3D-printing system 100 to 3D print or manufacture a 3D part. The controller 116 may control actuators to cause a pre-made part 104 to be positioned at a desired location on working surface 102. The controller 116 may further control actuators to cause the printhead 108 to apply successive layers of build material 106 to the pre-made part 104 to fill or grow the pre-made part 104.

The controller 116 may further control the printhead 108 and material hoppers 110a-c to dynamically vary the composition of the build material 106 by causing materials 112a-c to be mixed in different proportions. In an example, the controller 116 may cause the composition of the build material 106 to be dynamically varied such that a mechanical performance of the build material 106 may change from a first portion of the filled pre-made part to a second portion of the filled pre-made part. For instance, the hardness of the build material 106 may decrease (e.g., from hard 120 to soft 118) and an energy-absorption capability of the build material 106 may increase from the first portion of the filled pre-made part to the second portion of the filled pre-made part. Thus, the build material 106 may comprise a plurality of materials 112a-c and the composition of the build material 106 may be dynamically varied by changing proportions of the materials 112a-c.

The controller 116 may cause the composition of the build material 106 to be dynamically varied to achieve a variety of gradient structures. In one example, the first portion may be a surface of the filled pre-made part, and the second portion may be a center of the filled pre-made part. In other examples, the first and the second portions may be a surface, a center, an internal location, a side, an edge, a corner, etc. of the filled pre-made part. For instance, the composition of the build material 106 may be dynamically varied to achieve a side-to-side gradient, an edge-to-edge gradient, a corner-to-corner gradient, a side-to-center gradient, an edge-to-corner gradient, an internal-location-to-surface gradient, etc.

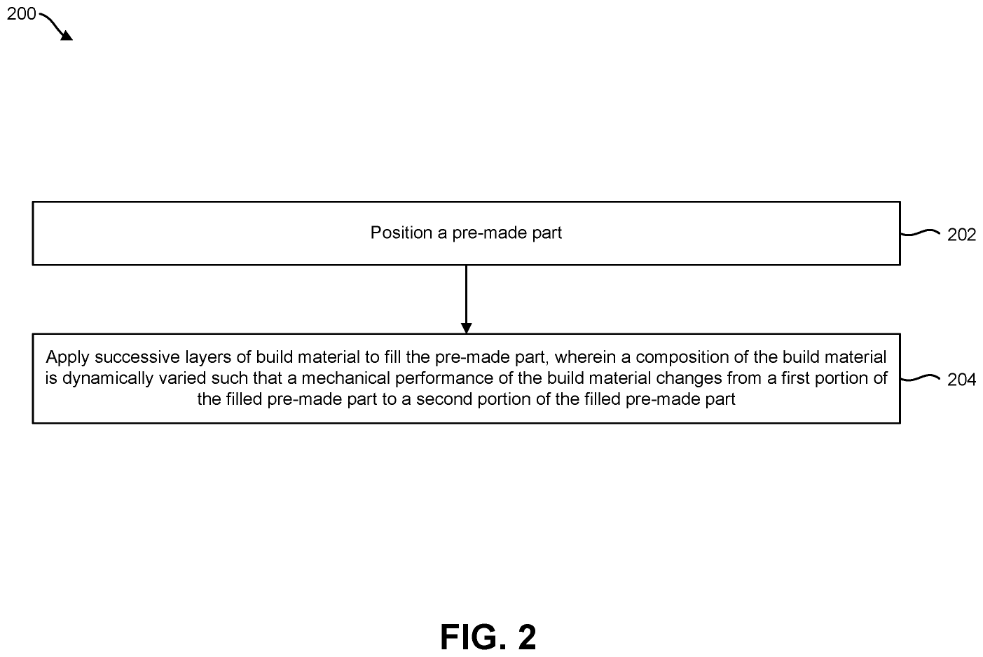

FIG. 2 is a flow diagram illustrating an example of a 3D-printing method. The 3D-printing method 200 may be performed by, for example, 3D-printing system 100. The 3D-printing system 100 may position 202 a pre-made part 104. The 3D-printing system 100 may apply 204 successive layers of build material 106 to fill the pre-made part 104. The 3D-printing system 100 may dynamically vary a composition of the build material 106 such that a mechanical performance of the build material 106 changes from a first portion of the filled pre-made part to a second portion of the filled pre-made part. In one example, the first portion may be a surface of the filled pre-made part, and the second portion may be a center of the filled pre-made part. In other examples, the first and the second portions may be a surface, a center, an internal location, a side, an edge, a corner, etc. of the filled pre-made part.

In one example, a hardness of the build material 106 may decrease (e.g., from hard 120 to soft 118) and an energy-absorption capability of the build material 106 may increase from the first portion of the filled pre-made part to the second portion of the filled pre-made part. The build material 106 may comprise a plurality of materials 112a-c. The 3D-printing system 100 may dynamically vary the composition of the build material 106 by changing proportions of the materials 112a-c.

In an example, the materials 112a-c may comprise a powder and a liquid. The materials 112a-c may be dissimilar. For instance, materials 112a-c may have different hardness and/or strength. Mixing materials 112a-c in different proportions may enable the manufacture of near net-shape 3D parts according to functional needs, such as having a wear-resistant exterior and an energy-absorbing interior. The pre-made part 104 may be manufactured from a material that provides additional wear-resistance to the 3D-printed part. For example, the pre-made part 104 may comprise a thermoplastic polyurethane.

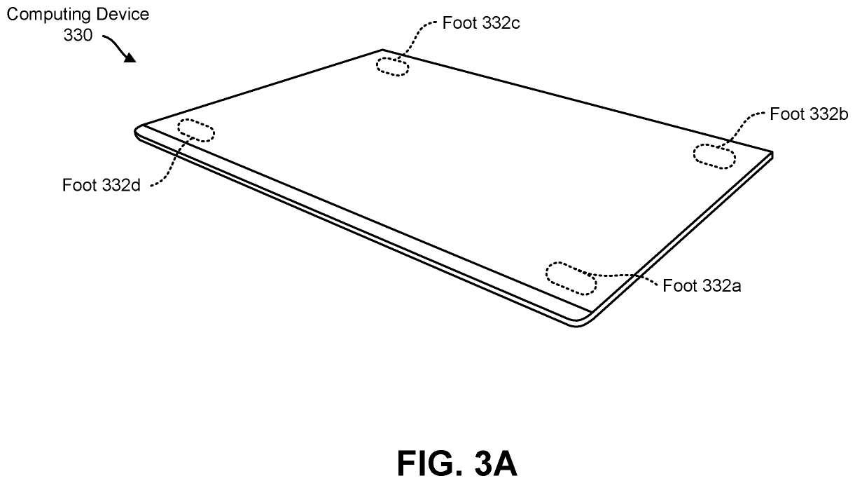

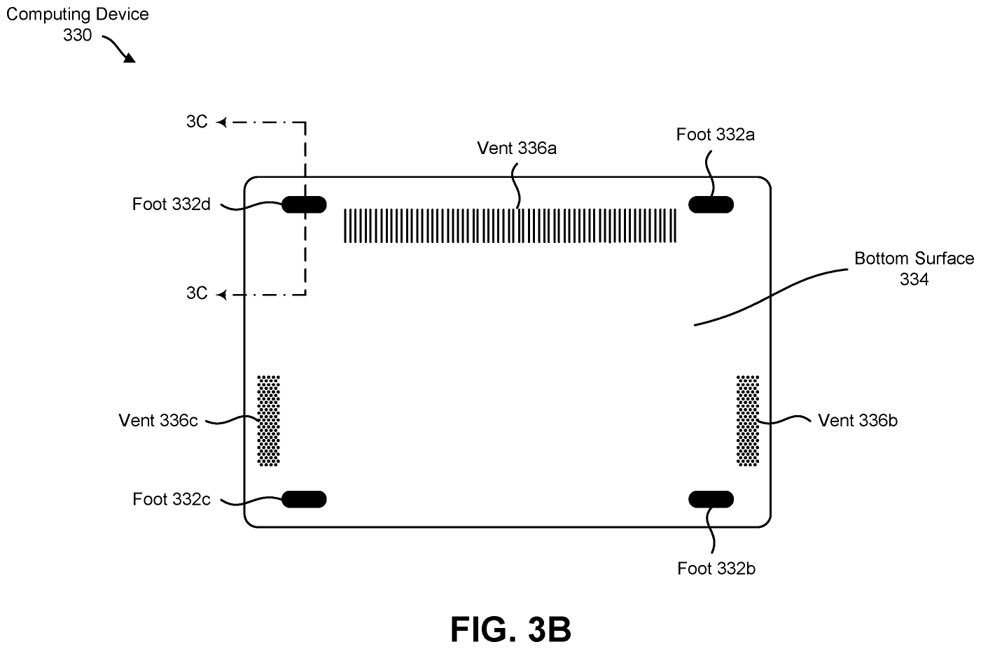

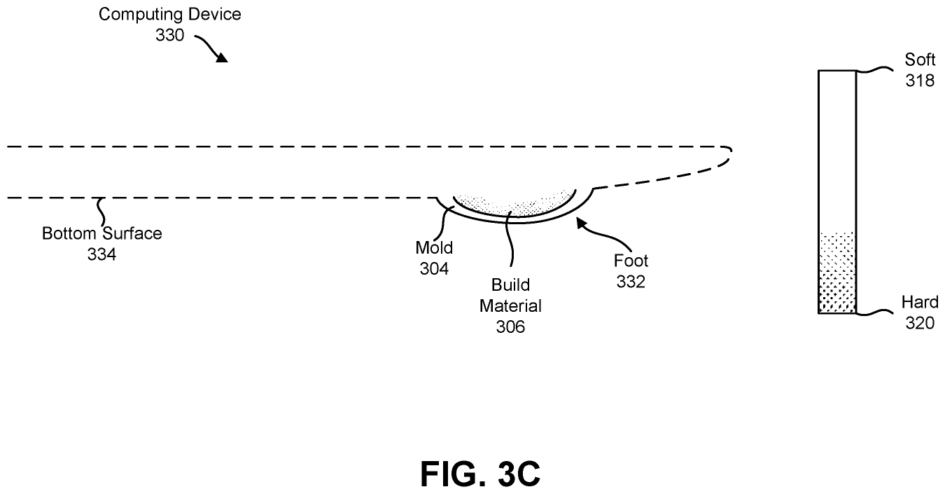

FIG. 3A is a perspective view of an example of a computing device 330. The computing device 330 shown may be an example of a laptop or notebook computer. In other examples, the computing device 330 may be another type of computer or another type of electronic device other than a computing device 330. The computing device 330 may include feet 332a-d connected to a bottom surface of the computing device 330. In the example of FIG. 3A, four feet 332a-d are shown and positioned near the corners of the bottom surface of the computing device 330. In other examples, the feet 332 may be positioned in other locations and/or different quantities of feet 332 may be used.

FIG. 3B is a bottom view of an example of a computing device 330. The computing device 330 may include a bottom surface 334, feet 332a-d, and vents 336a-c. The feet 332a-d may be connected to the bottom surface 334. The feet 332a-d may be designed to protect the computing device 330 against vibrations and impact. The feet 332a-d may be positioned so as not to interfere with vents 336a-c. In the example of FIG. 3B, four feet 332a-d are shown and positioned near the corners of the bottom surface 334 of the computing device 330. In other examples, the feet 332 may be positioned in other locations and/or different quantities of feet 332 may be used.

FIG. 3C is a cross-sectional view of an example of a foot 332 connected to a bottom surface 334 of a computing device 330 of FIG. 3B. FIG. 3C is a view along line 3C of FIG. 3B. The computing device 330 may include a bottom surface 334 and a foot 332 connected to the bottom surface 334. The foot 332 may comprise a mold 304 and build material 306 filling the mold 304. The foot 332 may be manufactured by a 3D-printing system 100 using a 3D-printing method, such as that described in FIG. 2.

In an example, a composition of the build material 306 may vary such that a mechanical performance of the build material 306 may change from a first portion of the filled mold to a second portion of the filled mold. For instance, a wear resistance of the build material 306 may decrease (e.g., from hard 320 to soft 318) and a vibration-absorption capability of the build material 306 may increase from the first portion of the filled mold to the second portion of the filled mold.

In one example, the first portion may be a surface of the filled mold, and the second portion may be a center of the filled mold. In other examples, the first and the second portions may be a surface, a center, an internal location, a side, an edge, a corner, etc. of the filled mold. The mold 304 may comprise a wear-resistant material. This may enable an exterior portion of the foot 332 to provide durability and wear-resistance, and the interior portion of the foot 332 to provide protection against vibration and impact

FIG. 4A is a perspective view of an example of a mold 404. In some examples, the mold 404 may be used to manufacture a foot 332 for a computing device 330. The mold 404 may comprise a hollow cylinder 440 with a tapered closed end 442. The hollow cylinder 440 may further comprise an open end 444.

FIG. 4B is a cross-sectional view of an example of a mold 404 of FIG. 4A. FIG. 4B is a view along line 4B of FIG. 4A. The tapered closed end 442 may comprise a tapered hollow cylindrical portion 452 with a wide end 446 and a narrow end 448. The narrow end 448 may comprise a solid cylindrical portion 450. In this example, the wide end 446 of the tapered hollow cylindrical portion 452 may be coupled to the hollow cylindrical portion 454. The narrow end 448 of the tapered hollow cylindrical portion 452 may be coupled to the solid cylindrical portion 450.

FIG. 4C is a cross-sectional view of an example of a mold 404 of FIG. 4A that has been filled with a build material 406. FIG. 4C illustrates a filled mold 456 viewed along line 4B of FIG. 4A. The filled mold 456 may comprise a mold 404 and build material 406. The build material 406 may be successively applied to the mold 404 using, for example, a 3D-printing system 100. For instance, the 3D-printing system 100 may apply successive layers of build material 406 to fill the mold 404 to a desired geometry.

In an example, the build material 406 may vary such that a mechanical performance of the build material 406 changes from a first portion of the filled mold 456 to a second portion of the filled mold 456. For instance, as illustrated in FIG. 4C, a hardness of the build material 406 may decrease (e.g., from hard 420 to soft 418) and an energy-absorption capability of the build material increases from a first portion of the filled mold 456 to a second portion of the filled mold 456. In this example, the first portion may be a surface of the filled mold 456, and the second portion may be a center of the filled mold 456. In other examples, the first and the second portions may be a surface, a center, an internal location, a side, an edge, a corner, etc. of the filled mold 456. The mold 404 may comprise a wear-resistant material. In this manner, the filled mold 456 may include a hard, wear-resistant exterior and a soft, energy-absorbent interior. In one example, the filled mold 456 may be used as a foot 332 for a computing device 330.

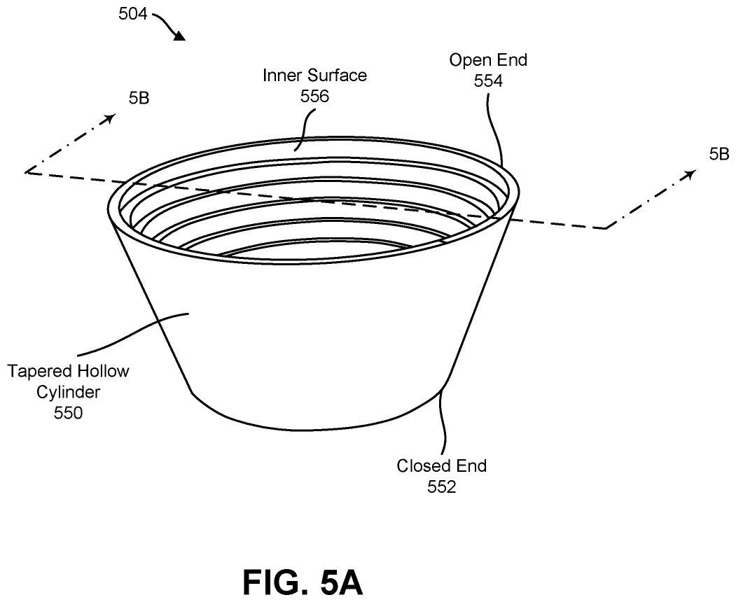

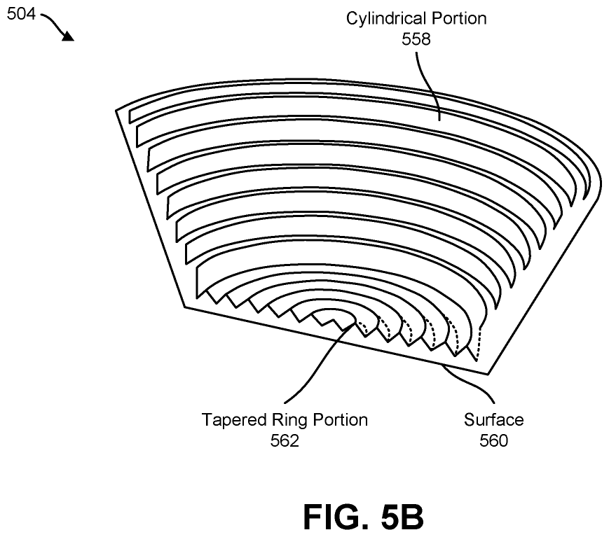

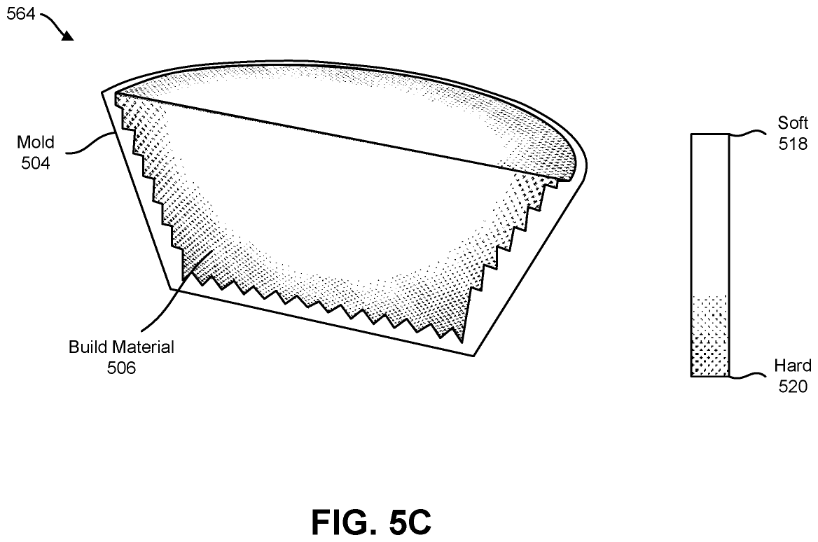

FIG. 5A is a perspective view of another example of a mold 504. In some examples, the mold 504 may be used to manufacture a foot 332 for a computing device 330. The mold 504 may comprise a tapered hollow cylinder 550 with a closed end 552, an open end 554, and an inner surface 556.

FIG. 5B is a cross-sectional view of an example of a mold 504 of FIG. 5A. FIG. 5B is a view along line 5B of FIG. 5A. The inner surface 556 of tapered hollow cylinder 550 may include a plurality of cylindrical portions 558 in a stepped arrangement. The stepped arrangement of the plurality of cylindrical portions 558 may create a coarse inner surface 556. The closed end 552 may include surface 560. Surface 560 may comprise a plurality of tapered ring portions 562 in a concentric arrangement. The concentric arrangement of the plurality of tapered ring portions 562 may also create a coarse surface 560.

FIG. 5C is a cross-sectional view of an example of a mold 504 of FIG. 5A that has been filled with a build material 506. FIG. 5C illustrates a filled mold 564 viewed along line 5B of FIG. 5A. The filled mold 564 may comprise a mold 504 and build material 506. The build material 506 may be successively applied to the mold 504 using, for example, a 3D-printing system 100. For instance, the 3D-printing system 100 may apply successive layers of build material 506 to fill the mold 504 to a desired geometry. The stepped arrangement of the plurality of cylindrical portions 558 on inner surface 556 and the concentric arrangement of tapered ring portions 562 on surface 560 may enhance bonding between mold 504 and build material 506.

In an example, the build material 506 may vary such that a mechanical performance of the build material 506 changes from a first portion of the filled mold 564 to a second portion of the filled mold 564. For instance, as illustrated in FIG. 5C, a hardness of the build material 506 may decrease (e.g., from hard 520 to soft 518) and an impact-absorption capability of the build material increases from a first portion of the filled mold 564 to a second portion of the filled mold 564. In this example, the first portion may be a surface of the filled mold 564, and the second portion may be a center of the filled mold 564. In other examples, the first and the second portions may be a surface, a center, an internal location, a side, an edge, a corner, etc. of the filled mold 564. The mold 504 may comprise a wear-resistant material. In this manner, the filled mold 564 may include a hard, wear-resistant exterior and a soft, energy-absorbent interior. In one example, the filled mold 564 may be used as a foot 332 for a computing device 330.

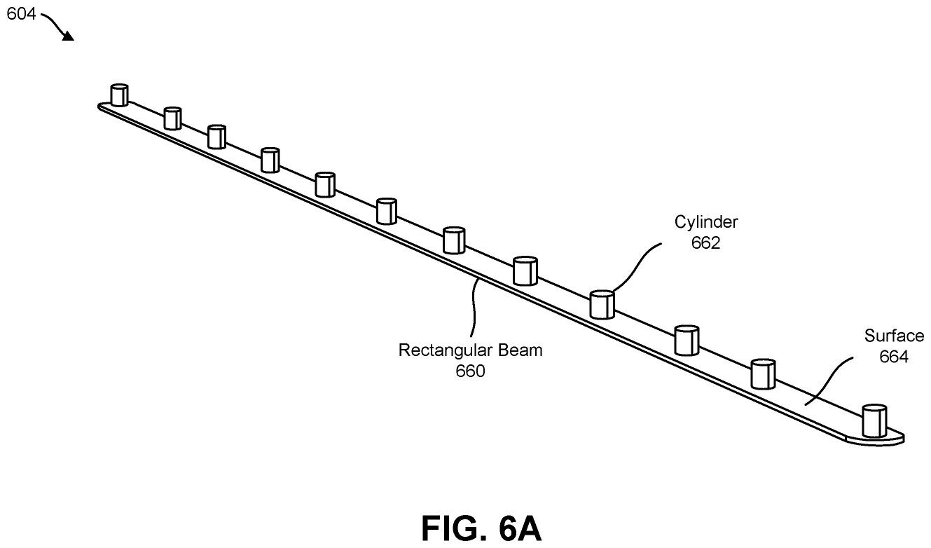

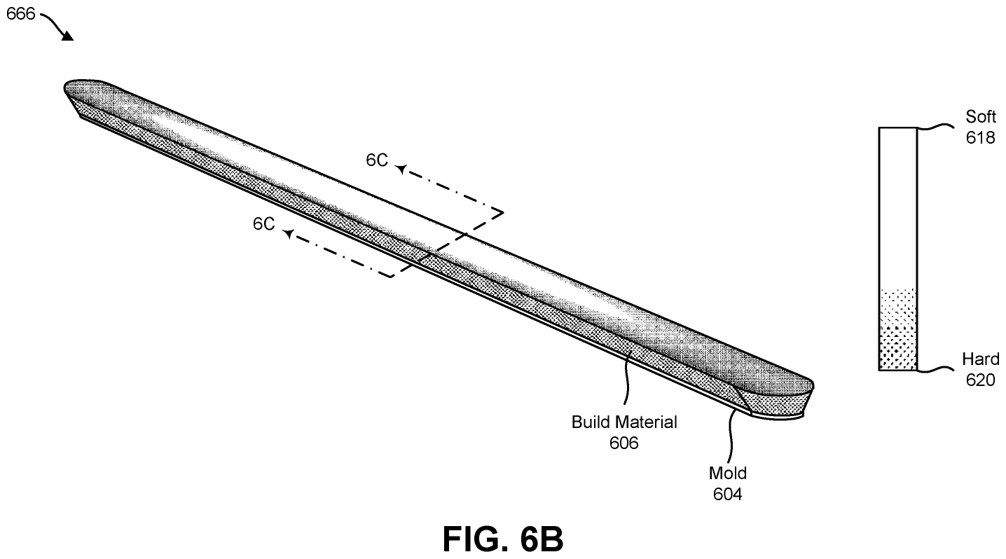

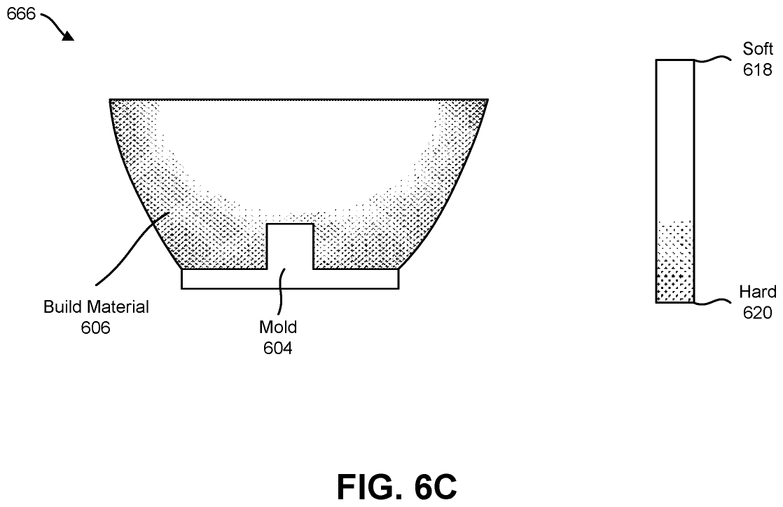

FIG. 6A is a perspective view of another example of a mold 604. In some examples, the mold 604 may be used to manufacture a foot 332 for a computing device 330. The mold 604 may comprise a rectangular beam 660 and a plurality of cylinders 662. The plurality of cylinders 662 may be coupled to a surface 664 of the rectangular beam 660 in a linear arrangement. In some examples, such as the example illustrated in FIG. 6A, the rectangular beam 660 may include rounded corners.

FIG. 6B is a perspective view of an example of a mold 604 of FIG. 6A that has been filled with a build material 606. The filled mold 666 may comprise a mold 604 and build material 606. The build material 606 may be successively applied to the mold 604 to fill the mold 604 using, for example, a 3D-printing system 100. For instance, the 3D-printing system 100 may apply successive layers of build material 606 to surface 664 to grow the filled mold 666 to a desired geometry using a desired hardness (e.g., on a scale from hard 620 to soft 618) for each layer and/or each voxel.

FIG. 6C is a cross-sectional view of an example of a mold 604 of FIG. 6A that has been filled with a build material 606. FIG. 6C is a view along line 6C of FIG. 6B. The filled mold 666 may comprise a mold 604 and build material 606. The build material 606 may be successively applied to the mold 604 using, for example, a 3D-printing system 100.

In an example, the build material 606 may vary such that a mechanical performance of the build material 606 changes from a first portion of the filled mold 666 to a second portion of the filled mold 666. For instance, as illustrated in FIG. 6C, a hardness of the build material 606 may decrease (e.g., from hard 620 to soft 618) and a vibration-absorption capability of the build material increases from a first portion of the filled mold 666 to a second portion of the filled mold 666. In this example, the first portion may be a surface of the filled mold 666, and the second portion may be a center of the filled mold 666. In other examples, the first and the second portions may be a surface, a center, an internal location, a side, an edge, a corner, etc. of the filled mold 666. The mold 604 may comprise a wear-resistant material. In this manner, the filled mold 666 may include a hard, wear-resistant exterior and a soft, energy-absorbent interior. In one example, the filled mold 666 may be used as a foot 332 for a computing device 330.

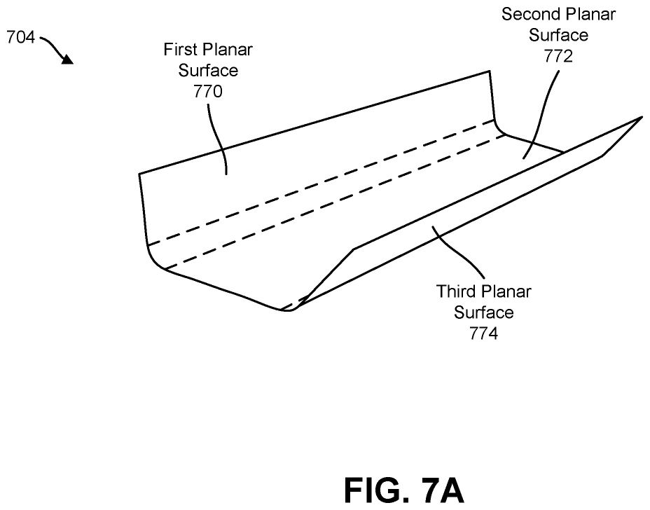

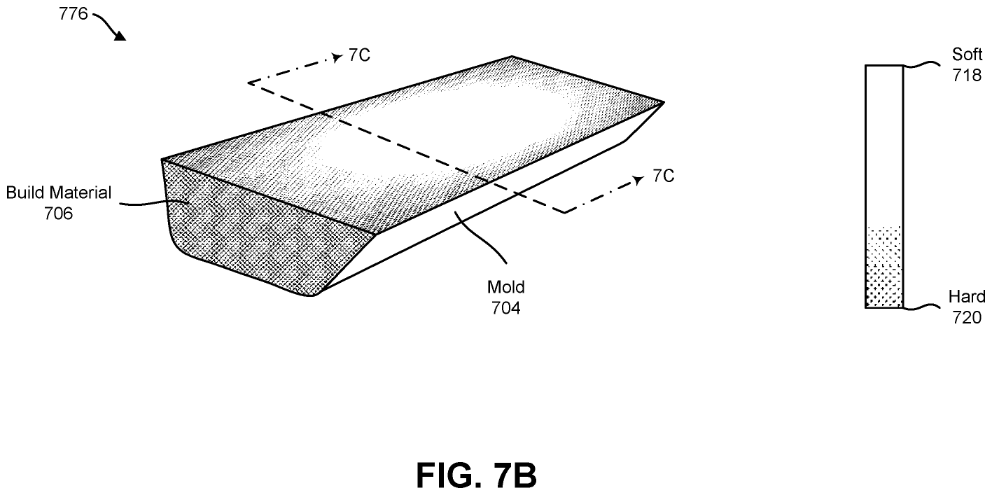

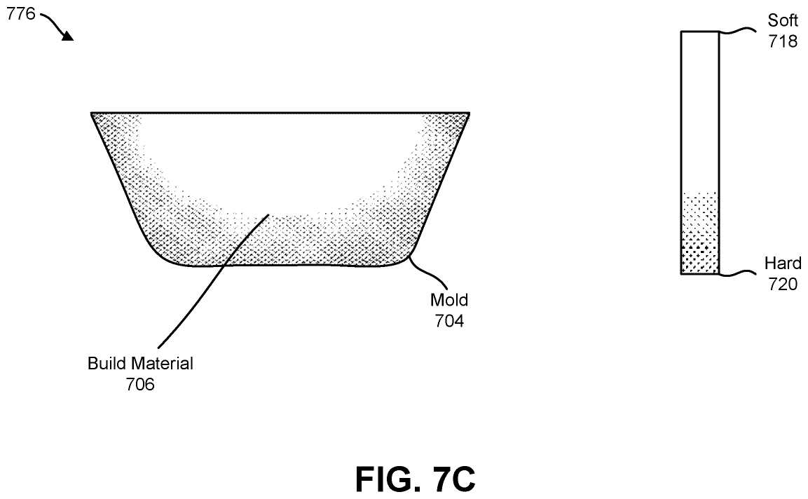

FIG. 7A is a perspective view of another example of a mold 704. In some examples, the mold 704 may be used to manufacture a foot 332 for a computing device 330. The mold 704 may comprise a first planar surface 770, a second planar surface 772, and a third planar surface 774. The first planar surface 770 and the third planar surface 774 may be angled relative to the second planar surface 772 to form a trough shape. In some examples, the angling of the first planar surface 770, second planar surface 772, and third planar surface 774 may produce a distinct corner. In other examples, like that shown in FIG. 7A, the angling of the first planar surface 770, second planar surface 772, and third planar surface 774 may produce a gradual curve.

FIG. 7B is a perspective view of an example of a mold 704 of FIG. 7A that has been filled with a build material 706. The filled mold 776 may comprise a mold 704 and build material 706. The build material 706 may be successively applied to the mold 704 to fill the mold 704 using, for example, a 3D-printing system 100. For instance, the 3D-printing system 100 may apply successive layers of build material 706 to fill the mold 704 to a desired geometry using a desired hardness (e.g., on a scale from hard 620 to soft 618) for each layer and/or each voxel.

FIG. 7C is a cross-sectional view of an example of a mold 704 of FIG. 7A that has been filled with a build material 706. FIG. 7C is a view along line 7C of FIG. 7B. The filled mold 776 may comprise a mold 704 and build material 706. The build material 706 may be successively applied to the mold 704 using, for example, a 3D-printing system 100.

In an example, the build material 706 may vary such that a mechanical performance of the build material 706 changes from a first portion of the filled mold 776 to a second portion of the filled mold 776. For instance, as illustrated in FIG. 7C, a hardness of the build material 706 may decrease (e.g., from hard 720 to soft 718) and an energy-absorption capability of the build material increases from a first portion of the filled mold 776 to a second portion of the filled mold 776. In this example, the first portion may be a surface of the filled mold 776, and the second portion may be a center of the filled mold 776. In other examples, the first and the second portions may be a surface, a center, an internal location, a side, an edge, a corner, etc. of the filled mold 776. The mold 704 may comprise a wear-resistant material. In this manner, the filled mold 776 may include a hard, wear-resistant exterior and a soft, energy-absorbent interior. In one example, the filled mold 776 may be used as a foot 332 for a computing device 330.

What is claimed is:

1. A three-dimensional (3D)-printing method, comprising:
positioning a pre-made part; and
applying successive layers of build material to fill the pre-made part, wherein a composition of the build material is dynamically varied such that a mechanical performance of the build material changes from a first portion of the filled pre-made part to a second portion of the filled pre-made part.

2. The 3D-printing method of claim 1, wherein a hardness of the build material decreases and an energy-absorption capability of the build material increases from the first portion of the filled pre-made part to the second portion of the filled pre-made part.

3. The 3D-printing method of claim 1, wherein the build material comprises a plurality of materials, and wherein the composition of the build material is dynamically varied by changing proportions of the materials.

4. The 3D-printing method of claim 3, wherein the materials comprise a powder and a liquid.

5. The 3D-printing method of claim 1, wherein the pre-made part comprises a thermoplastic polyurethane.

6. A foot, comprising:
a mold; and
build material filling the mold, wherein a composition of the build material varies such that a mechanical performance of the build material changes from a first portion of the filled mold to a second portion of the filled mold.

7. The foot of claim 6, wherein the mold comprises a hollow cylinder with a tapered closed end.

8. The foot of claim 6, wherein the mold comprises a tapered hollow cylinder with a closed end, an inner surface of the tapered hollow cylinder comprising a plurality of cylindrical portions in a stepped arrangement.

9. The foot of claim 8, wherein a surface of the closed end comprises a plurality of tapered ring portions in a concentric arrangement.

10. The foot of claim 6, wherein the mold comprises:
a rectangular beam; and
a plurality of cylinders coupled to a surface of the rectangular beam in a linear arrangement.

11. The foot of claim 6, wherein the mold comprises a first planar surface, a second planar surface, and a third planar surface; and
wherein the first planar surface and the third planar surface are angled relative to the second planar surface to form a trough shape.

12. A computing device, comprising:
a bottom surface; and
a foot connected to the bottom surface, the foot comprising a mold and build material filling the mold, wherein a composition of the build material varies such that a mechanical performance of the build material changes from a first portion of the filled mold to a second portion of the filled mold.

13. The computing device of claim 12, wherein a wear resistance of the build material decreases and a vibration-absorption capability of the build material increases from the first portion of the filled mold to the second portion of the filled mold.

14. The computing device of claim 12, wherein the mold comprises a wear-resistant material.
